(19) United States
(12) Patent Application Publication
(10) Pub. No.: US 2022/0332977 A1
(43) Pub. Date: Oct. 20, 2022

(54) CMP COMPOSITIONS FOR POLISHING DIELECTRIC MATERIALS

(71) Applicant: ENTEGRIS, INC., Billerica, MA (US)

(72) Inventors: Akshay RAJOPADHYE, Gainesville, FL (US); Rajiv K. SINGH, Newberry, FL (US); Sunny DE, Gainesville, FL (US)

(21) Appl. No.: 17/232,947

(22) Filed: Apr. 16, 2021

(51) Int. Cl. C09G 1/02; C09K 3/14; C03C 19/00; B24B 37/04; B24B 7/24

(52) U.S. Cl. CPC C09G 1/02; C09K 3/1436; C03C 19/00; B24B 37/044; B24B 7/24

(57) ABSTRACT

Provided are improved slurry compositions useful in the CMP polishing of glass and other dielectric materials. In one aspect, the compositions of the invention are comprised of water; silica abrasive; a cationic surfactant; and ceria abrasive. The compositions effect a high removal rate while limiting the number of scratches typically observed when utilizing ceria alone.

### TECHNICAL FIELD

The present invention generally relates to improved compositions and methods for polishing glass and other dielectric surfaces.

### BACKGROUND

Microelectronic device wafers are used to form integrated circuits. The microelectronic device wafer includes a substrate, such as silicon, into which regions are patterned for deposition of different materials having insulative, conductive or semi-conductive properties.

Besides microelectronic devices, materials such as glass and other dielectric materials are used as optical transparent screens for computers, smart phones, and other electronic devices.

In order to obtain the correct patterning, excess material used in forming the layers on the substrate must be removed. Further, to fabricate functional and reliable circuitry, it is often important to prepare a flat or planar microelectronic wafer surface prior to subsequent processing. Thus, it is necessary to planarize and/or polish certain surfaces of a microelectronic device wafer. Additionally, for optical devices, it may be necessary to smooth the surfaces for optical transmission or to remove sub-surface damage.

Chemical Mechanical Polishing or Planarization (“CMP”) is a process in which material is removed from a surface of a microelectronic device wafer, and the surface is planarized and polished by coupling a physical process such as abrasion with a chemical process such as oxidation or chelation. In its most rudimentary form, CMP involves applying slurry, e.g., a solution of an abrasive and an active chemistry, to a polishing pad that buffs the surface of a microelectronic device wafer to achieve the removal, planarization, and polishing processes. It is not typically desirable for the removal or polishing process to be comprised of purely physical or purely chemical action, but rather the synergistic combination of both in order to achieve fast, uniform removal. In the fabrication of integrated circuits, the CMP slurry should also be able to preferentially remove films that comprise complex layers of metals and other materials so that highly planar surfaces can be produced for subsequent photolithography, patterning, etching, and thin-film processing. In conventional CMP operations, a substrate carrier or polishing head is mounted on a carrier assembly and positioned in contact with a polishing pad in a CMP apparatus. The carrier assembly provides a controllable pressure to the substrate pressing the substrate against the polishing pad. The pad is moved relative to the substrate.

The industry standard abrasive used in polishing dielectric materials such as glass, silica, and silica-silicon nitride structures is ceria (CeO₂). Ceria generally exhibits high reactivity with the surface to be polished, which results in a relatively high removal rate. However, Ceria tends to result in a poor surface finish on these substrates, as unacceptable deep scratches are generally formed, resulting in a final surface area which has high defectivity. Accordingly, there is a need for improved abrasives and slurries containing such abrasives for use in polishing dielectric materials such as glass.

### SUMMARY

In summary, the invention provides improved slurry compositions useful in the CMP polishing of dielectric materials. In one embodiment the dielectric material is glass. In one aspect, the compositions of the invention are comprised of water; silica abrasives which are optionally modified with a coating resulting from treatment with a nucleating agent, followed by a per-compound; and a cationic surfactant. Such compositions are useful as performance-enhancing additives to be added to conventional ceria slurry compositions, thus forming the compositions of the invention. The present invention thus provides slurry compositions which effect a high removal rate while limiting the level of defectivity typically observed when utilizing a ceria slurry alone.

### BRIEF DESCRIPTION OF THE DRAWINGS

FIG. 1 shows the removal rate in microns per minute of removal of a glass surface, comparing ceria alone, silica alone, and a composition of the invention.

FIG. 2 shows the removal rate in microns per minute of removal of a TEOS surface, comparing ceria alone, silica alone (i.e., unmodified colloidal silica), and a ceria plus ADD 2 as set forth in the examples.

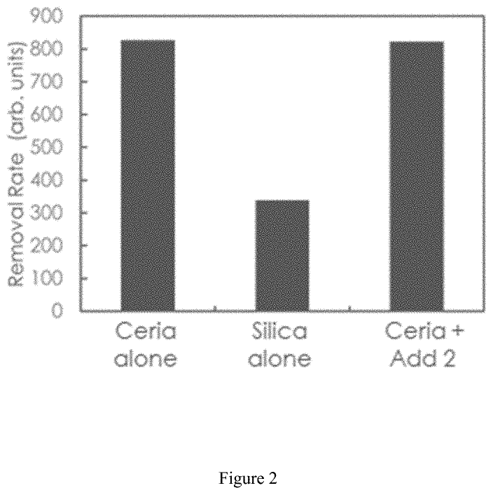

FIG. 3 is a surface finish comparison showing a glass surface polished with a standard ceria slurry. (Ra (average roughness): 0.81 nm)

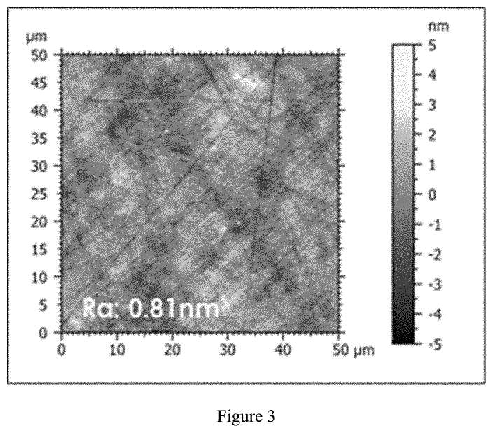

FIG. 4 is a surface finish comparison showing a glass surface polished with a composition of the invention. (Ra 0.54 nm)

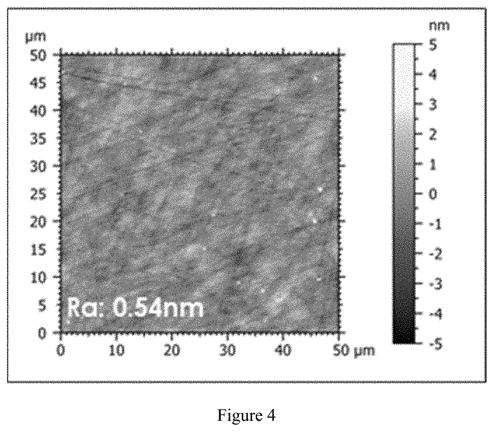

### DETAILED DESCRIPTION OF THE INVENTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

The compositions of this invention are useful as CMP polishing compositions (i.e., slurries) for dielectric materials, such as glass. Further examples of such materials include, for example, tetraethyl orthosilicate (TEOS), fluorinated silica glass, carbon-doped silicon glass, glass ceramics, zirconium silicate, barium titanate, silicon nitride, silicon oxynitrides, and carbon-doped silicon oxide (SiOC). These substrate materials may be polycrystalline, or amorphous, and can have more than one phase. The substrate materials can be in the form of an epitaxial layer or comprise a bulk substrate single crystal.

Accordingly, the invention provides in a first aspect, a composition comprising:
a. water;
b. a silica abrasive;
c. a cationic surfactant, and
d. a ceria abrasive.

In the compositions of the invention, the term “silica” refers to an unmodified silica chosen from commercially-available colloidal silica, having an average particle size of about 20 nm to about 150 nm, available from Fuso Chemical Co., Ltd., Ecolab, and Nouryon to name a few. In this disclosure, “average size” refers to an average value based on a volume or weight distribution of the particle size distribution. Colloidal silica particles are defined as particles made from silicate-based precursors such as sodium silicate and potassium silicate. Colloidal silica is known to have bound hydroxyl ions which impart a negative charge under neutral pH conditions. The concentration of the silica particles can vary from 0.000001 weight percent to 50 weight percent, or about 0.05 weight percent to about 20 weight percent, based on the total weight of the composition (i.e., slurry).

The ceria particles used in the compositions of the second aspect, i.e., CeO₂, are of a size and size distribution as is typically used in CMP operations, and have a size (i.e., diameter) of generally from about 1 nm to about 100 microns. The concentration of the ceria particles can vary from 0.000001 weight percent to 50 weight percent, based on the total weight of the composition or about 0.05 weight percent to about 10 weight percent, based on the total weight of the composition (i.e., slurry). In one embodiment, the average particle size of the ceria which is used in microelectronic applications, is about 10 nm to about 250 nm. In another embodiment, for applications involving the polishing of optical devices, the average particle size is about 250 nm to about 10 μm. Ceria abrasives are well known in the CMP art and are commercially available from Nyacol Nano Technologies, Inc., Cabot, and Ferro, to name a few. Examples of suitable ceria abrasives include wet-process ceria, calcined ceria, and metal-doped ceria, among others. The composition can comprise a single type of ceria abrasive particles or multiple different types of abrasive particles, based on size, composition, method of preparation, particle size distribution, or other mechanical or physical properties. Ceria abrasive particles can be made by a variety of different processes. For example, ceria abrasive particles can be precipitated ceria particles or condensation-polymerized ceria particles, including colloidal ceria particles.

In certain embodiments, the component b. of the composition of the invention is comprised of modified silica abrasives. In further embodiments, the component b. comprises a mixture of silica abrasives and modified silica abrasives.

The modified silica abrasive materials have a film or coating of one or more colloidal metal oxides. Such coatings cover at least a portion of the surface area of the silica particles. In one embodiment, the modified silica abrasive materials can be prepared by first treating the silica particles with a nucleating agent. In one embodiment, the nucleating agents are chosen from substituted glycine compounds, which are believed to serve as nucleating agents at the surface of the silica. In certain embodiments, the substituted glycine compounds have the formula

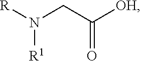

wherein R is chosen from hydrogen or C₁-C₆ alkyl having one or two hydroxyl groups, and R¹ is chosen from C₁-C₆ alkyl having one or two hydroxyl groups.

In other embodiments, the substituted glycine compounds are chosen from 2-(bis-2-hydroxyethyl)amino)acetic acid, commonly known as bicine, and N-(2-hydroxy-1,1-bis(hydroxymethyl)ethyl)glycine, commonly known as tricine.

Next, the silica product is treated with a per-compound. Typical examples of per-compound types include permanganate, peroxide, perchlorate, and persulfate compounds. One particular per-compound type is an alkali metal (e.g., sodium, lithium, potassium, or barium) of permanganate, or a mixture of a per-compound with one component being a permanganate. In such cases, the colloidal metal oxide coating or film will comprise manganese oxide. Optionally, hydrogen permanganate can also be used. A permanganate is the general name for a chemical compound containing the permanganate (VII) ion, MnO⁻⁴. Because manganese for permanganate is in the +7 oxidation state, the permanganate ion is a strong oxidizing agent. The term persulfate (sometimes known as peroxysulfate or peroxodisulfate) refers to ions or compounds containing the anions SO₅²⁻ or S₂O₈²⁻.

Examples of specific per-based compound (oxidizers) include Potassium Permanganate (KMnO₄), sodium Permanganate (NaMnO₄), Potassium Peroxoborate (KBO₃), Potassium Peroxochromate (K₃CrO₈), Potassium Peroxodisulfate (K₂S₂O₈), Potassium Perrhenate (KReO₄). The oxidation state of manganese in these permanganates is +7, which is the highest oxidation state for manganese. A mixture of per-compounds can also be used. In one embodiment, the per compound is potassium permanganate. The concentration of per-compounds can, in certain embodiments, vary from about 0.1 mM to about 5 mM.

Accordingly, in another embodiment, the colloidal metal oxide coating is a coating resulting from treating the silica with a nucleating agent and a per-compound.

The resulting modified silica material is then combined with other desired ingredients and mixed with a cationic surfactant. As used herein, the term “surfactant” refers to an organic compound that lowers the surface tension (or interfacial tension) between two liquids or between a liquid and a solid, typically an organic amphiphilic compound that contains a hydrophobic group (e.g., a hydrocarbon (e.g., alkyl) “tail”) and a hydrophilic group. The surfactants described herein can be used individually or in a mixed state. In general, the concentration of surfactants used in the compositions of the invention depends on the type of surfactant utilized, the surfaces of the particular abrasive particles and the substrate material being polished.

Cationic surfactants are essentially surface-active molecules which possess at least one positively-charged moiety. In one embodiment, the cationic surfactant is chosen from C₆-C₁₈ ammonium halides. The “C₆-C₁₈” modifier refers the number of carbon atoms in the surfactant and may include aliphatic and aromatic moieties. In another embodiment, the cationic surfactant is chosen from C₁₂-C₁₈ ammonium halides.

Exemplary cationic surfactants include, but are not limited to, cetyl trimethylammonium bromide (CTAB) (also known as hexadecyltrimethyl ammonium bromide), hexadecyltrimethyl ammonium chloride (CTAC), heptadecanefluorooctane sulfonic acid, tetraethylammonium halides, stearyl trimethylammonium chloride, 4-(4-diethylaminophenylazo)-1-(4-nitrobenzyl)pyridium bromide, cetylpyridinium chloride monohydrate, benzalkonium chloride, benzethonium chloride benzyldimethyldodecylammonium chloride, benzyldimethylhexadecylammonium chloride, hexadecyltrimethylammonium bromide, dimethyldioctadecylammonium chloride, dodecyltrimethylammonium chloride, didodecyldimethylammonium bromide, di(hydrogenated tallow)dimethylammonium chloride, tetraheptylammonium bromide, tetrakis(decyl)ammonium bromide, and oxyphenonium bromide, dimethyldioctadecylammonium chloride, dimethyldihexadecylammonium bromide, and di(hydrogenated tallow)dimethylammonium chloride. In one embodiment, the cationic surfactant is chosen from hexadecyltrimethyl ammonium bromide, hexadecyltrimethyl ammonium chloride, and benzalkonium chloride.

In certain embodiments of the invention, in addition to the cationic surfactant, the composition further comprises at least one additional surfactant chosen from anionic and nonionic surfactants.

The anionic or nonionic surfactants, when present, is in certain embodiments about 0.0001% to about 5% by weight (wt), or about 0.001% to about 2% by wt, compared with the total wt of the composition.

Anionic surfactants are generally surfactants which are characterized by a negatively charged hydrophilic polar group. Exemplary anionic surfactants include polyacrylic acid, polymethacrylic acid, a polystyrene-acrylic acid copolymer, an acrylic acid-maleic acid copolymer, an acrylic acid-ethylene copolymer, an acrylic acid-acrylamide copolymer, and an acrylic acid-poly acrylamide copolymer. Such anionic surfactants may have a weight average molecular weight of 1,000 to 30,000. In other embodiments, the weight average molecular weight of the anionic surfactant is from about 1,000 to about 25,000, or from about 1,500 to about 25,000, or about 1,500 to about 20,000

Other examples of anionic surfactants include carboxylic acid salts, sulfonic acid salts such as alkylbenzene sulfonic acid, sulfuric acid ester salts, phosphoric acid ester salts, and the like. Further examples include dioctyl sodium sulfosuccinate (DOSS), perfluorooctanesulfonate (PFOS), linear alkylbenzene sulfonates, sodium lauryl ether sulfate, lignosulfonate, and sodium stearate.

Exemplary nonionic surfactants include PolyFox PF-159 (OMNOVA Solutions), polyethylene glycol) (“PEG”), poly(propylene glycol) (“PPG”), ethylene oxide/propylene oxide block copolymers such as Pluronic F-127 (BASF), a polysorbate polyoxyethylene (20) sorbitan monooleate (Tween™ 80)(Croda Americas), polyoxyethylene (20) sorbitan monostearate (Tween™ 60), polyoxyethylene (20) sorbitan monopalmitate (Tween™ 40), polyoxyethylene (20) sorbitan monolaurate (Tween™ 20)), polyoxypropylene/polyoxyethylene block copolymers (e.g., Pluronic L31, Plutonic 31R1, Pluronic 25R2 and Pluronic 25R4), polyoxyethylene glycol octylphenol ethers, polyoxyethylene glycol alkylphenol ethers, and combinations thereof.

The compositions of the invention may optionally contain one or more additional components, such as conditioners, dispersants, and pH modifiers such as acids and bases.

The slurry can also further comprise pH stabilizers. Both organic and inorganic pH stabilizers can be used. Examples of inorganic pH stabilizers include phosphate, phthalates, bicarbonates, silicates. Examples of organic pH stabilizers include amines, glycine, N-cyclohexyl-2-aminoethanesulfonic acid. In certain embodiments, the compositions of the invention will have a pH of about 3 to about 13. In another embodiment, the composition will have a pH of about 9 to about 11.

The slurry composition can also further comprise a fungicide. Examples of fungicides include tetramethylammonium chloride, tetraethylammonium chloride, tetrapropylammonium chloride, alkylbenzyldimethylammonium chloride, and alkylbenzyldimethylammoniumhy-droxide, 3,5-di-methyl tetrahydro 1,3,5,2H-thiadiazine-2 thione, 2-methyl-4-isothiazolin-3-one and 5-chloro-2-methyl-4-isothiazolin-3-one, sodium chlorite and sodium hypochlorite.

The polishing process can be performed at a temperature of from about 15° C. to about 100° C. Higher temperatures are expected to increase the polishing rate of glass and other dielectric materials. In one embodiment, the temperature range is about 25° C. to about 65° C. One way to reach a higher temperature is to preheat the slurry before being supplied to the CMP apparatus.

Regarding the polishing pad, any type of polymer-based polishing pad can generally be used. Examples of polishing pads are based on polyurethane pads and suede pads. The pad thickness can vary from 0.1 mm to 25 mm. The hardness of the suede pads can vary from Asker C hardness of 5 to Asker Hardness of 95. The compressibility of the suede pad can be from 0.1% to 40%. The pore size of the suede poromeric pads can vary from 2 microns to 100 microns with the size in the range of 20 to 60 microns in one embodiment. The poromeric pad layer can have a backing pad layer of poly(ethylene terephthalate)(PET), or foam or non-woven material with thickness between 30 microns to 25 mms.

Besides poromeric pads, polyurethane pads can also be used. Examples of polyurethane based pads include D-100 pads from Cabot Microelectronics, IC and Suba Series from Dow Electronics Materials. The hardness of such pads range from Shore D value of 5 to 99. The porosity of such pads can vary from 0.1% to 40%. It is noted that generally any other type of polymeric material can be used with the slurry. Besides the use of poromeric pads, metal pads (such as cast iron, copper, tin), granite, or resin surfaces can be also used as pads.

Suitable apparatuses for chemical mechanical polishing are commercially available. The method of the invention generally involves mixing the slurry composition, comprising the components set forth above, placing the dielectric substrate to be polished into a CMP apparatus having a rotating pad, and then performing chemical mechanical polishing using the slurry compositions of the invention. In this method of polishing, at least some of the dielectric substrate surface will be removed or abraded, thereby providing a suitably polished dielectric substrate.

Accordingly, in another aspect, the invention provides a method for chemical mechanical polishing a substrate which includes a surface comprising a dielectric material, the method comprising:
a. contacting the substrate with the composition of the invention;
b. moving the composition relative to the substrate, and
c. abrading the substrate to remove a portion of the dielectric surface, thereby providing a polished dielectric surface.

The compositions of the invention are easily formulated by simple addition of the respective ingredients and mixing to homogeneous condition. The compositions may be readily formulated as single-package formulations or multi-part formulations that are mixed at or before the point of use. The concentrations of the respective ingredients may be widely varied in specific multiples of the composition, i.e., more dilute or more concentrated, and it will be appreciated that the compositions as described herein can variously and alternatively comprise, consist, or consist essentially of any combination of components consistent with this disclosure.

Accordingly, in another aspect, the invention provides a kit, including in one or more containers, the components chosen from a., b., c., and d., as set forth above, for combination at the point of use.

### EXAMPLES

### Example 1

An optical glass wafer was polished using a 12″ Buehler polishing machine as a function of applied downforce at a platen speed of 150 RPM. DuPont Suba800 pad was chosen for polishing the glass substrate. The down pressure was varied between 2 and 6 psi. The flowrate of the polishing medium was maintained constant at 30 ml/min while the polishing duration was fixed at 5 minutes. The polishing medium contained an embodiment of hybrid particles which consisted of two abrasives—ceria and functionalized colloidal silica particles (i.e., “modified silica” as referred to herein). The size of the ceria particles was 1.5 microns. The concentration of ceria particles was kept constant at 1 wt %. The concentration of functionalized silica particles varied from 0.05 wt %-3.5 wt %. The temperature rise on the pad was measured during the polishing process using an IR thermometer. The removal rate was determined at pH 9 and 4.5 which was used to determine the performance of each slurry composition. The pH of the polishing medium was adjusted using aqueous solutions of potassium hydroxide and nitric acid.

Prior to mixing with the ceria abrasive to formulate the hybrid particles, the colloidal silica particles were functionalized. In order to functionalize them, the silica particles were treated with potassium permanganate. The concentration of potassium permanganate was maintained at 3.8 mM. Bicine was used as a nucleating agent facilitate the formation of colloidal manganese dioxide particles which are then coated onto the silica particles. Cetyl trimethylammonium bromide (CTAB) was used as cationic surfactant. The concentration of CTAB was maintained at 2 mM in the overall slurry. Secondary alkyl sulfonate (SAS) was used as a rheology modifier. The concentration of SAS was kept at 0.2 wt % of the slurry. Two additives were prepared for testing purpose which shall henceforth be called ADD 1 (functionalized silica with no SAS) and ADD 2 (functionalized silica with SAS).

The performance metrics included (a) removal rate (b) surface finish (c) scratch profile/depth (d) additive stability (determined based on the settlement of the additive in a test tube over time). The removal rate was determined based on the reduction in the weight of the glass wafer during the polishing process. A factor was calculated to convert the weight loss in grams into the removal rate in terms of μm/hour. This factor takes into consideration the surface area of the glass wafer and the material density. The glass surface after polish was scanned using atomic force microscope to determine the surface roughness and the scratch depth resulting after each polishing. A 50 μm×50 μm scan size was selected for analysis.

Table 1 represents the removal rate data for ceria particles alone (control) as well as hybrid particles prepared using two different silica particles, as a function of down pressure. The data proves that the polishing follows Prestonian behavior.

Table 2 represents the removal rate data for the same set of slurry composition as a function of the volume % of the additive. The higher volume % of additive results in higher removal rate.

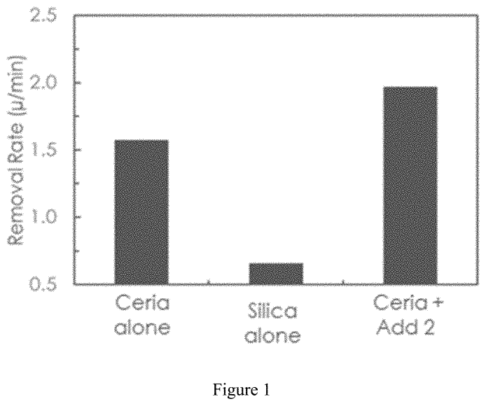

FIG. 1 shows the surface roughness profile of the glass wafer after polish. Polishing using ceria alone results in higher surface roughness along with deeper scratch profile. The glass surface polished with the hybrid particles exhibits lower Ra value with shallow and a smaller number of scratches.

TABLE 1
Removal rate data at pH 11 for ceria alone and the
hybrid particles as a function of downforce. The silica
additive was maintained at 10 volume percent.

| Down | Removal Rate (μ/min) | | |
|---|---|---|---|
| Pressure | Ceria Alone | Ceria + ADD 1 | Ceria + ADD 2 |
| 2 | 0.75 | 0.94 | 0.69 |
| 4 | 1.27 | 1.51 | 1.19 |
| 6 | 1.58 | 2.28 | 1.88 |

TABLE 2
Removal rate data at pH 11 for the hybrid particle slurry as a function
of volume percent of the functionalized silica additive at 6 psi

| | |
|---|---|
| Additive | Removal Rate |

| vol % | Ceria + ADD 1 | Ceria + ADD 2 |
|---|---|---|
| 0 | 1.58 | 1.58 |
| 2.5 | 1.36 | — |
| 5 | 1.87 | 1.90 |
| 7.5 | 1.81 | 1.80 |
| 10 | 2.28 | 1.97 |

### Example 2

In this example, multiple polishing slurries were prepared with the varying particle sizes of the ceria abrasive and the effect was tested on the removal rates of the glass substrate using the same protocol set forth in example 1. The particle size was varied from 1.5 micron to 5 microns. All ceria particles were sourced from different suppliers. Each slurry had same proportion of the additive 1, which was 10 vol % of the total volume of slurry. Table 3 represents the removal rates obtained by applying the down pressure of 6 psi at pH 11. It was observed that the removal rate reduced as the particle size of the ceria abrasive increased.

TABLE 3
removal rate data at 6 psi, pH 11 as a function of ceria particle size

| | | Ceria particle | |
|---|---|---|---|
| Slurry | Formulation | size (μ) | Removal Rate |
| 1 | Ceria + ADD 1 | 1.5 | 2.28 |
| 2 | Ceria + ADD 1 | 2.5 | 1.78 |
| 3 | Ceria + ADD 1 | 5.0 | 1.50 |

### Example 3

In this example, multiple polishing slurries were prepared with the varying concentrations of the ceria particles and the effect on the removal rate was tested as per the polishing conditions set forth in example 1. The ceria concentration was varied from 0.1 wt % to 1.5 wt %. Each slurry had same proportion of the additive 1, which was 10 vol % of the total slurry volume. Table 4 shows the removal rate data for glass substrate in presence of ceria abrasive alone as well as the two additives.

TABLE 4
Removal rate data at 6 psi and pH 11 as a function
of concentration of ceria in weight percent

| Slurry | formulation | Ceria concentration (wt %) | Removal rate |
|---|---|---|---|
| 1 | Ceria alone | 0.1 | 0.94 |
| 2 | Ceria alone | 0.25 | 1.39 |
| 3 | Ceria + ADD 1 | 0.25 | 1.39 |
| 4 | Ceria + ADD 2 | 0.25 | 1.4 |
| 5 | Ceria alone | 0.5 | 1.65 |
| 6 | Ceria + ADD 1 | 0.5 | 1.65 |
| 7 | Ceria + ADD 2 | 0.5 | 1.6 |
| 8 | Ceria alone | 1 | 1.59 |
| 9 | Ceria + ADD 1 | 1 | 2.28 |
| 10 | Ceria + ADD 2 | 1 | 1.97 |
| 11 | Ceria alone | 1.5 | 1.9 |
| 12 | Ceria + ADD 2 | 1.5 | 2.07 |

### Example 4

In this example, removal rates of the different deposited films were compared with respect to the optical glass substrates in order to study the selectivity of the polishing slurry on various substrates. Selectivity in the polishing rates can be a crucial parameter for various CMP applications. The removal rates of TEOS films and SiN films were compared with those of optical glass. Both TEOS and SiN films were deposited on silicon substrates via PECVD and were obtained from DK Nanotechnology. Square samples of size 1.5 in×1.5 in were cut in order to polish in presence of the slurries tested. Selectivity in polishing rates was tested at applied down pressure of 4 psi. Table 5 shows the removal rates in μ/hr for all the substrates tested. From the data presented, it was seen that the selectivity for TEOS polishing in presence of the additive remained unaffected whereas that for silicon nitride was improved up to 4:1 compared to TEOS or optical glass.

TABLE 5
Removal rate data at 4 psi for various substrates

| Slurry | formulation | Polishing surface | Removal rate |
|---|---|---|---|
| 1 | Ceria alone | Optical glass | 1.27 |
| 2 | Ceria + ADD 2 | Optical glass | 1.2 |
| 3 | Ceria alone | TEOS | 12.3 |
| 4 | Ceria + ADD 2 | TEOS | 1.4 |
| 5 | Ceria alone | Silicon Nitride | 3.5 |
| 6 | Ceria + ADD 2 | Silicon Nitride | 5.14 |

Aspects

In a first aspect, the invention provides a composition comprising:
a. water;
b. a silica abrasive;
c. a cationic surfactant, and
d. a ceria abrasive.

In a second aspect, the invention provides the composition of the first aspect, wherein the silica abrasive is at least partially coated with a colloidal metal oxide.

In a third aspect, the invention provides the composition of the second aspect, wherein the colloidal metal oxide coating is a coating resulting from treating the silica with a nucleating agent and a per-compound.

In a fourth aspect, the invention provides the composition of the second, third, or fourth aspect, wherein the metal oxide is manganese oxide.

In a fifth aspect, the invention provides the composition of the third aspect, wherein the nucleating agent has the formula

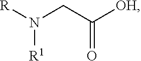

wherein R is chosen from hydrogen or C₁-C₆ alkyl having one or two hydroxyl groups, and R¹ is chosen from C₁-C₆ alkyl having one or two hydroxyl groups.

In a sixth aspect, the invention provides the composition of any one of the third through fifth aspects, wherein the nucleating agent is chosen from 2-(bis-2-hydroxyethyl)amino)acetic acid, and N-(2-hydroxy-1,1-bis(hydroxymethyl)ethyl)glycine.

In a seventh aspect, the invention provides the composition of any one of the second through the sixth aspects, wherein the per-compound is chosen from potassium permanganate, sodium permanganate, potassium peroxoborate, potassium peroxochromate, potassium peroxodisulfate, and potassium perrhenate, or a mixture thereof.

In an eighth aspect, the invention provides the composition of any one of the first through seventh aspects, wherein the cationic surfactant is chosen from C₆-C₁₈ ammonium halides.

In a ninth aspect, the invention provides the composition of any one of the first through eighth aspects, wherein the cationic surfactant is chosen from C₁₂-C₁₈ ammonium halides.

In a tenth aspect, the invention provides the composition of any one of the first through ninth aspects, wherein the cationic surfactant is chosen from hexadecyltrimethyl ammonium bromide, hexadecyltrimethyl ammonium chloride, and benzalkonium chloride.

In an eleventh aspect, the invention provides the composition of any one of the first through tenth aspects, further comprising one or more surfactants chosen from anionic surfactants and nonionic surfactants.

In a twelfth aspect, the invention provides a method for chemical mechanical polishing a substrate which includes a surface comprising a dielectric material, the method comprising:
A. contacting the substrate with a composition comprising:
   a. water;
   b. a silica abrasive;
   c. a cationic surfactant, and
   d. a ceria abrasive;
B. moving the composition relative to the substrate, and
C. abrading the substrate to remove a portion of the dielectric surface, thereby providing a polished dielectric surface.

In a thirteenth aspect, the invention provides the method of the twelfth aspect, wherein the silica abrasive is at least partially coated with a colloidal metal oxide.

In a fourteenth aspect, the invention provides the method of the thirteenth aspect, wherein the metal oxide is manganese oxide.

In a fifteenth aspect, the invention provides the method of any one of the twelfth through fourteenth aspects, wherein the cationic surfactant is chosen from C₁₂-C₁₈ ammonium halides.

In a sixteenth aspect, the invention provides the method of any one of the twelfth through fifteenth aspects, wherein the cationic surfactant is chosen from hexadecyltrimethyl ammonium bromide, hexadecyltrimethyl ammonium chloride, and benzalkonium chloride.

In a seventeenth aspect, the invention provides the method of any one of the thirteenth through the sixteenth aspects, wherein the colloidal metal oxide coating is a coating resulting from treating the silica with a nucleating agent and a per-compound.

In an eighteenth aspect, the invention provides the method of the seventeenth aspect, wherein the nucleating agent has the formula

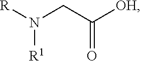

wherein R is chosen from hydrogen or C₁-C₆ alkyl having one or two hydroxyl groups, and R¹ is chosen from C₁-C₆ alkyl having one or two hydroxyl groups.

In a nineteenth aspect, the invention provides the method of the twelfth, seventeenth, or eighteenth aspect, wherein the nucleating agent is chosen from 2-(bis-2-hydroxyethyl)amino)acetic acid, and N-(2-hydroxy-1,1-bis(hydroxymethyl)ethyl)glycine.

In a twentieth aspect, the invention provides the method of any one of the seventeenth through nineteenth aspects, wherein the per-compound is chosen from potassium permanganate, sodium permanganate, potassium peroxoborate, potassium peroxochromate, potassium peroxodisulfate, and potassium perrhenate, or a mixture thereof.

In a twenty-first aspect, the invention provides the method of any one of the thirteenth through twentieth aspects, wherein the metal oxide is manganese oxide.

In a twenty-second aspect, the invention provides the method of any one of the twelfth through the twenty-first aspects, wherein the cationic surfactant is chosen from C₁₂-C₁₈ ammonium halides.

In a twenty-third aspect, the invention provides the method of any one of the twelfth through the twenty-second aspects, wherein the cationic surfactant is chosen from hexadecyltrimethyl ammonium bromide, hexadecyltrimethyl ammonium chloride, and benzalkonium chloride.

In a twenty-fourth aspect, the invention provides the method of any one of the twelfth through the twenty-third aspects, wherein the dielectric surface is chosen from glass, tetraethyl orthosilicate, fluorinated silica glass, carbon-doped silicon glass, glass ceramics, zirconium silicate, barium titanate, silicon nitride, silicon oxynitrides, and carbon doped silicon oxide.

In a twenty-fifth aspect, the invention provides the method of any one of the twelfth through the twenty-fourth aspects, wherein the dielectric surface is glass.

In a twenty-sixth aspect, the invention provides a kit, including in one or more containers, components chosen from components a., b., c., and d. of any one of the first and the seventh through eleventh aspects.

In a twenty-seventh aspect, the invention provides the kit of the twenty-sixth aspect, wherein component b. is silica and component c. is chosen from hexadecyltrimethyl ammonium bromide, hexadecyltrimethyl ammonium chloride, and benzalkonium chloride.

In a twenty-eighth aspect, the invention provides the kit of the twenty-sixth aspect, wherein component b. is a silica abrasive which is at least partially coated with magnesium oxide and component c. is chosen from hexadecyltrimethyl ammonium bromide, hexadecyltrimethyl ammonium chloride, and benzalkonium chloride.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is in many respects, only illustrative. The disclosure's scope is, of course, defined in the language in which the appended claims are expressed.

What is claimed is:

1. A composition comprising:
a. water;
b. a silica abrasive;
c. a cationic surfactant, and
d. a ceria abrasive.

2. The composition of claim 1, wherein the silica abrasive is at least partially coated with a colloidal metal oxide.

3. The composition of claim 2, wherein the colloidal metal oxide coating is a coating resulting from treating the silica with a nucleating agent and a per-compound.

4. The composition of claim 2, wherein the metal oxide is manganese oxide.

5. The composition of claim 3, wherein the nucleating agent has the formula 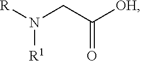
wherein R is chosen from hydrogen or C₁-C₆ alkyl having one or two hydroxyl groups, and R¹ is chosen from C₁-C₆ alkyl having one or two hydroxyl groups.

6. The composition of claim 3, wherein the nucleating agent is chosen from 2-(bis-2-hydroxyethyl)amino)acetic acid, and N-(2-hydroxy-1,1-bis(hydroxymethyl)ethyl)glycine.

7. The composition of claim 3, wherein the per-compound is chosen from potassium permanganate, sodium permanganate, potassium peroxoborate, potassium peroxochromate, potassium peroxodisulfate, and potassium perrhenate, or a mixture thereof.

8. The composition of claim 1, wherein the cationic surfactant is chosen from C₆-C₁₈ ammonium halides.

9. The composition of claim 1, wherein the cationic surfactant is chosen from C₁₂-C₁₈ ammonium halides.

10. The composition of claim 1, wherein the cationic surfactant is chosen from hexadecyltrimethyl ammonium bromide, hexadecyltrimethyl ammonium chloride, and benzalkonium chloride.

11. The composition of claim 1, further comprising one or more surfactants chosen from anionic surfactants and nonionic surfactants.

12. A method for chemical mechanical polishing a substrate which includes a surface comprising a dielectric material, the method comprising:
A. contacting the substrate with a composition comprising:
a. water;
b. a silica abrasive;
c. a cationic surfactant, and
d. a ceria abrasive;
B. moving the composition relative to the substrate, and
C. abrading the substrate to remove a portion of the dielectric surface, thereby providing a polished dielectric surface.

13. The method of claim 12, wherein the silica abrasive is at least partially coated with a colloidal metal oxide.

14. The method of claim 12, wherein the metal oxide is manganese oxide.

15. The method of claim 12, wherein the cationic surfactant is chosen from C₁₂-C₁₈ ammonium halides.

16. The method of claim 12, wherein the cationic surfactant is chosen from hexadecyltrimethyl ammonium bromide, hexadecyltrimethyl ammonium chloride, and benzalkonium chloride.

17. The method of claim 12, wherein the dielectric surface is chosen from glass, tetraethyl orthosilicate, fluorinated silica glass, carbon-doped silicon glass, glass ceramics, zirconium silicate, barium titanate, silicon nitride, silicon oxynitrides, and carbon doped silicon oxide.

18. The method of claim 12, wherein the dielectric surface is glass.

19. A kit, including in one or more containers, components chosen from components a., b., c., and d. of claim 1.

20. The kit of claim 19, wherein b. is silica, and c. is a cationic surfactant chosen from hexadecyltrimethyl ammonium bromide, hexadecyltrimethyl ammonium chloride, and benzalkonium chloride
